(19) United States
(12) Patent Application Publication
(10) Pub. No.: US 2023/0249375 A1
(43) Pub. Date: Aug. 10, 2023

(54) Combustion chain saw cover modified by adapters

(71) Applicant: RODRIQUE LEBLANC, JOLY (CA)

(72) Inventor: RODRIQUE LEBLANC, JOLY (CA)

(21) Appl. No.: 17/803,090

(22) Filed: Feb. 4, 2022

(51) Int. Cl. B27B 17/00

(52) U.S. Cl. CPC B27B 17/00

(57) ABSTRACT

A combustion chain saw with its pulley cover modified by adapters to allow its starting-up with an external cordless electric drill.

### CROSS REFERENCE TO RELATED APPLICATIONS

“Not applicable”

### BACKGROUND OF THE INVENTION

My invention relates to a start device for chain saws having a combustion engine. Up to now most combustion chain saws are started by a rewind pulling rope. There is a patent granted that shows a lithium-ion battery starter for combustion chain saws that does not seem to be widely on the market yet.

Contrarily to lawn mowers, chain saws flywheels turn reversibly resulting in an unscrewing of the flywheel nut when attempting a starting-up with an electric drill. Furthermore, apart from being possibly damageable, an electric drill starting directly on the flywheel nut, possible on some lawn mowers, is not practible on an operational combustion chain saw since there is no access to its flywheel nut without removing its pulley rope cover essential to its operationally.

Here is how my invention is new since it consists in using an external electric drill that drives reversibly the flywheel pulley of the chain saw, made possible by my further described adapters, in the same way as if did by rope pulling.

Different from the said combustion chain saw incorporated lithium-ion battery starter earlier mentioned in development for small combustion engine, an without being less efficient, my invention is remarkably simple since it does not modify or add to the main components of a combustion chain saw except for its pulley cover on which either one of the said further described adapters are installed. The user could simply remove the pulley rope cover of his chain saw and replace it by the further described proper modified one. Mostly made of plastic their costs are very low.

For some users of combustion chain saw, rope starting is difficult or even impossible. My invention makes simple the starting of a combustion chain saw by the use of an external electric drill, method that will be more than welcome by users.

### BRIEF SUMMARY OF THE INVENTION

My invention consists in using an external cordless electric drill to start a combustion chain saw otherwise than by cranking reversibly with such drill directly on its flywheel nut. My said further described adapters on the pulley cover of the combustion chain saw allows to rotate reversibly its flywheel with an external electric drill as if it was done by rope pulling resulting in a start-up of the combustion chain saw.

### BRIEF DESCRIPTION OF THE DRAWINGS

The invention will now be described with reference to the drawings wherein:

FIG. 1 Shows a front view of a modified combustion chain saw pulley cover.

FIG. 2 Shows a back view of a modified combustion chain saw pulley cover with pulley and gear.

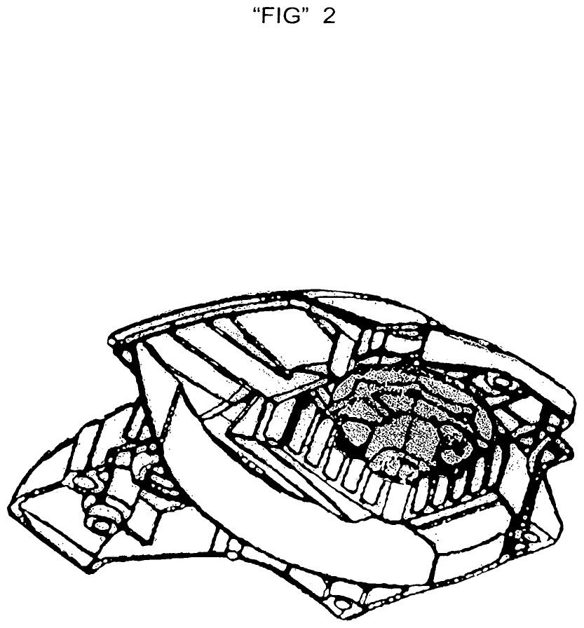

FIG. 3 Shows a back view of a modified combustion chain saw with pulley and pawls.

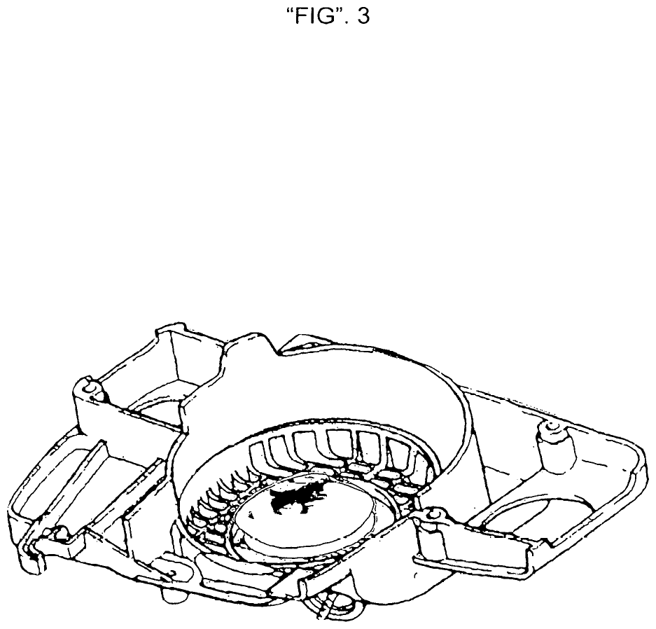

FIG. 4 Shows an exploded view of a modified combustion chain saw pulley cover with pulley and gear.

FIG. 5 Shows an exploded view of a modified combustion chain saw pulley cover with pulley and pawls.

### DETAILED DESCRIPTION OF THE INVENTION

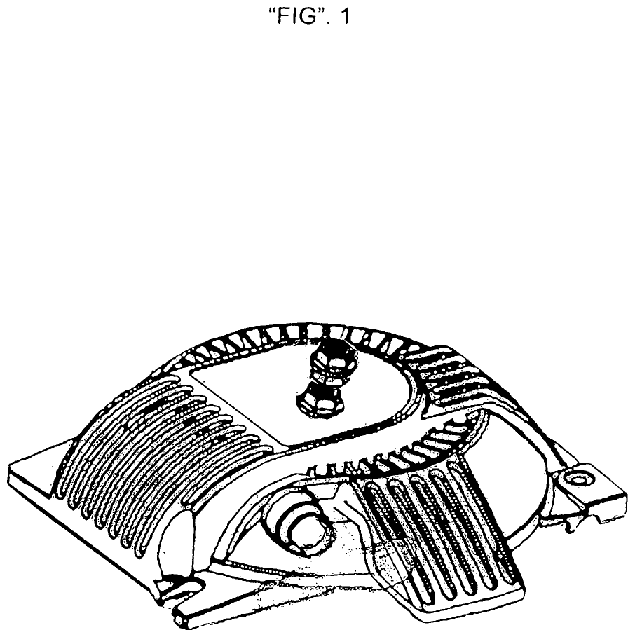

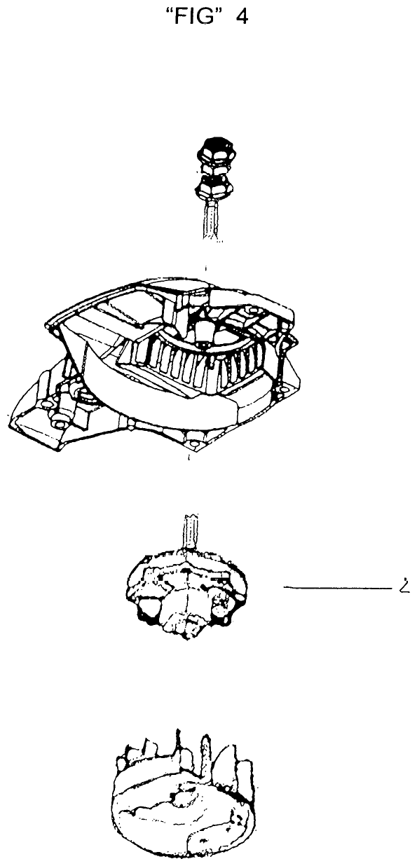

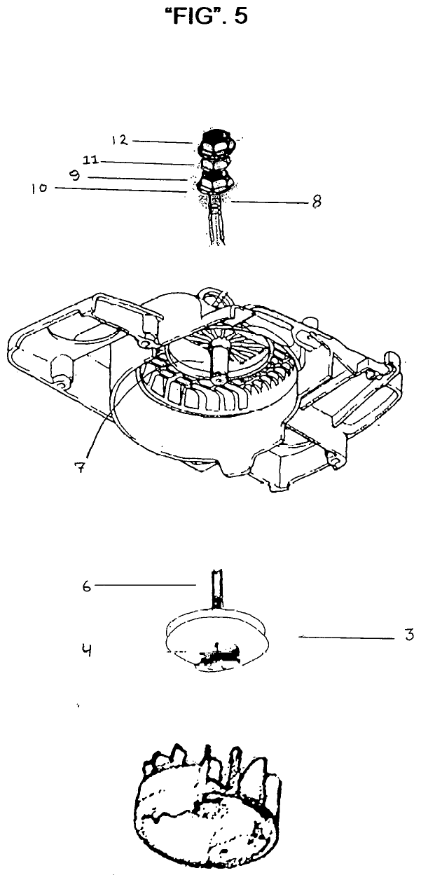

FIG. 1 Shows a modified combustion chain saw pulley cover. On said cover FIG. 1 the rope and the rewind spring are removed. FIG. 1 also used as front page view Two systems drives the flywheel when pulling the rope on most combustion chain saws. One is by a drive gear 2 FIG. 4 the other one is by a pulley with two incorporated pawls 3 FIG. 5 retained and activated by a spring clip 4 FIG. 5.

The essence of my invention is to have, on those two said types of corresponding combustion chain saws, their flywheels reversibly turning to make the engine start otherwise than by rope pulling.

Further described its consists in a simple modification to the pulley cover FIG. 1 possible on most combustion chain saws without any other changes to the rest of the said chain saws even to their flywheels.

Here is how it's done. An hexagonal bolt 6 FIG. 5 5/16×3 in. approximately passing all the way through, from their tops, the said previously drilled drive gear 2 FIG. 4 or the said pulley with pawls 3 FIG. 5 without the necessity to drill.

Said hexagonal head of the said bolt 6 FIG. 5 machined to obtain a grip with the drive gear 2 FIG. 4 for some chain saws or the pulley with pawls 3 FIG. 5 for others.

Each one of said hexagonal head of each said bolt 6 FIG. 5 with their respective gripped pulley with gear 2 FIG. 4 or pulley with pawls 3 FIG. 5 definitely seized respectively into one piece with epoxy.

For the said flywheel drive mechanism with pulley and pawls 3 FIG. 5, and before the said pulley cover modification, such said pawls are retained to the pulley by a spring clip 4 FIG. 5 said clip also serves to activate said pawls and to retain said pulley with pawls 3 FIG. 5 to the said plastic column 7 FIG. 5 of said other types of chain saws with pulley and pawls 3 FIG. 5.

Consequently to the said modification of the said chain saw pulley cover FIG. 1 the said spring clip 4 FIG. 5 still serves to activate the said pawls and to keep them in place on the pulley and also serves to retain the said pulley with pawls 3 FIG. 5 to the said plastic column 7 FIG. 5. Said spring clip 4 FIG. 5 placed, following said cover modification, on the shank of the said machined hexagonal bolt right next its bearing surface said clip must be kept capable to move freely once the said seizing with epoxy process is done.

The next step is to pass either one of the two treaded ends of each said bolts with their respective said on piece drive gear 2 FIG. 4 or pulley with pawls 3 FIG. 5 through a 5/16 in. hole drilled in the center of the pulley plastic column 7 FIG. 5 all the way through the said cover at its very center. Said molded plastic column 7 FIG. 5 serving on most chain saws as a seat for the drive gear 2 FIG. 4 or the pulley with pawls 3 FIG. 5. Said treaded end of bolt 8 FIG. 5 extending by about ¾ in. the exterior center of the said pulley cover is screwed and tighten lightly with a lock nut 9 FIG. 5 preceded by a washer 10 FIG. 5. Such said light tightening is to allow the said one piece bolt with its respective drive gear 2 FIG. 4 or pulley with pawls 3 FIG. 5 to rotate freely around the said plastic column 7 FIG. 5 of either one of the said modified combustion chain saw pulley cover. Then said treaded end of the bolt with said washer 10 FIG. 5 and said lock nut 9 FIG. 5 is then screwed by a regular nut 12 FIG. 5 locked in place by a preceded smaller wrench size nut 11 FIG. 5, said locked in place nut 12 FIG. 5 cranked reversibly by an external cordless electric drill to get the engine started on either one of the combustion chain saw with its said respective modified pulley cover.

1. The invention claimed is a combustion chain saw pulley cover modified by adapters to allow its starting-up with an external cordless electric drill comprising:
A combustion chain saw pulley plastic cover with a plastic pulley column seat molded to it and extending from its interior;
An hexagonal bolt 5/16 by approximately 3 in. with along its shank next to the bearing surface a drive gear with pulley solidly secured by an abrasive machining and a gluing with epoxy process, said hexagonal bolt with its bottom end treaded;
An hexagonal bolt 5/16 by approximately 3 in. with along its shank next to the bearing surface a pulley with pawls, said pawls retained by a spring clip, said pulley solidly secured by an abrasive machining and a gluing with epoxy process, said hexagonal bolt with its bottom end treaded;
and
A 5/16 in. washer a 5/16 in. lock nut and two other 5/16 in. nuts of different wrench size.

2. A combustion chain saw pulley cover modified by adapters to allow its starting-up with an external cordless electric drill as in claim 1, wherein said combustion chain saw pulley plastic cover with a plastic pulley column seat molded to it and extending from its interior, said plastic pulley column seat drilled by a 5/16 in. bit all the way through its center and through the said cover itself.

3. A combustion chain saw pulley cover modified by adapters to allow its starting-up with an external cordless electric drill as in claim 1 wherein said hexagonal bolt 5/16 by approximately 3 in. with either one of its said top secured drive components passing through the center of the said drilled 5/16 in hole of the said appropriate pulley column seat and through the said cover itself and then said hexagonal bolt extending the exterior face of said appropriate cover by about ¾ of an inch.

4. An hexagonal bolt 5/16 by approximately 3 in. as in claim 3 wherein said treaded end of said hexagonal bolt extending the face of said appropriate pulley cover by about ¾ of an inch is screwed, after a washer has been put in place, by a locknut tighten lightly to allow said bolt to rotate freely in the said column and by a further regular nut locked in place by a preceded smaller wrench size nut, said locked in place nut cranked reversibly by an external cordless electric drill to get the engine started on either one of the chain saw with its said respective modified pulley cover.
